(19) United States
(12) Patent Application Publication
(10) Pub. No.: US 2018/0221837 A1
(43) Pub. Date: Aug. 9, 2018

(54) APPARATUS AND METHOD FOR MIXING LIQUIDS

(71) Applicant: Michael John Ogilvie, Calgary (CA)

(72) Inventor: Michael John Ogilvie, Calgary (CA)

(21) Appl. No.: 15/424,465

(22) Filed: Feb. 3, 2017

(51) Int. Cl. B01F 13/08; B01F 7/18

(52) U.S. Cl. CPC B01F 13/089; B01F 7/18

(57) ABSTRACT

An apparatus for mixing a liquid comprise a base having an associated head located thereover, an elongate stirring member extending between top and bottom ends along an axis, wherein the top end is magnetically coupled with the head so as to suspend the elongate stirring member therefrom and wherein the bottom end includes at least two arms radially extending therefrom, and a rotary motor located within the base magnetically coupled to the at least two arms so as to cause the elongate stirring member to rotate with the rotary motor. A method for locating the elongate stirring member within the container, placing the container on the base at a mixing location so as to magnetically couple the stirring member with the head; and turning the rotary motor so as to cause the elongate stirring member to rotate with the rotary motor.

### BACKGROUND OF THE INVENTION

### 1. Field of Invention

The present invention relates generally to mixing liquids and in particular to a method and apparatus for mixing a solution within a container holding one or more liquid and/or solid.

### 2. Description of Related Art

In many fields it is necessary to mix a liquid which is a solution of one or more liquids and/or one or more solids to be dissolved into or suspended therein. It will be appreciated that examples of such fields may be found for example in laboratories, or the food service industry. In particular, it will be appreciated that the need to mix solutions in such fields requires the solution to be mixed thoroughly.

By way of non-limiting example, it will be appreciated that in some food service environments, it is frequently necessary to mix one or more liquids or dissolvable solids into the beverage. Such mixing however frequently requires an additional step prior to service to the customer. Such added steps are undesirable in many food service industries due to the additional time such steps take. As a result, the extra step of mixing the beverage may be frequently skipped to improve service time and increase production.

Furthermore, in other environments such as laboratories, it will be appreciated that it is undesirable to locate an object into a solution to be mixed where the object is later required to be removed therefrom. It will be appreciated that where such liquids or solids forming the solution are hazardous, such as in some laboratory environments, that such removal may be dangerous, or may also adversely affect the composition of the mixture.

Previous attempts to provide solution mixers have been unsatisfactory. In particular, some attempts have provided a separate mixing vessel with a mixing element in the bottom. Disadvantageously, such solutions require the solution to be mixed in such separate container and then poured into final container. Examples of such devices may be found, in for example, U.S. Pat. No. 5,425,579 to Sampson. It will be appreciated that for some industries, such separate container will be an additional step to pour out of after mixing, which will result in lower production or risk of spilling. Additionally, it will also be appreciated that the separate mixing containers will also require washing intermittently.

Applicant is also aware of devices for mixing liquids where a magnetic object is located within the solution wherein the magnetic object is attracted to and rotated by a rotating magnet under the container. Examples of such devices may be found in U.S. Pat. No. 6,712,497 B2 to Jersey et al. Disadvantageously, such systems require the magnetic object to be removed from the container after the solution is mixed which may be an undesirable additional step.

### SUMMARY OF THE INVENTION

According to a first embodiment of the present invention there is disclosed an apparatus for mixing a liquid comprising a base having an associated head located thereover, an elongate stirring member extending between top and bottom ends along an axis, wherein the top end is magnetically coupled with the head so as to suspend the elongate stirring member therefrom and wherein the bottom end includes at least two arms radially extending therefrom, and a rotary motor located within the base magnetically coupled to the at least two arms so as to cause the elongate stirring member to rotate with the rotary motor.

Each of the at least two arms may include a driven magnet in a distal end thereof from the axis. The driven magnets may have opposite polarity from each other. The at least two arms may comprise two arms extending in opposite directions from each other from the axis. The stirring member may be formed of a ferromagnetic material. The stirring member may include a suspended magnet at the top end thereof.

The head may be positioned above the base by a positioning arm. The head may include a suspension magnet therein for suspending the stirring member. The suspension magnet may be oriented to attract the stirring member. The suspension magnet may be encased within a non-magnetic material. The head may include an induction switch adapted to sense the presence of the stirring member and to selectively activate the motor in response thereto.

The base may include a platform for supporting a container containing a liquid to be mixed therein. The motor may be located below the platform. The platform may include a positioning member to position the container at the desired location for mixing.

The motor may include a rotary member magnetically coupleable to the arms of the stirring member. The rotary member may include a pair of drive magnets disposed thereon coupleable to the arms of the stirring member. The drive magnets may have opposite polarity from each other. The head may include a light adapted to be illuminated when the motor is activated.

According to a further embodiment of the present invention there is disclosed a kit for stirring liquids comprising a base having a plurality of mixing locations each having an associated head located thereover, a plurality of elongate stirring members extending between top and bottom ends along an axis, wherein the top end is magnetically coupled with the head so as to suspend the elongate stirring member therefrom and wherein the bottom end includes at least two arms radially extending therefrom, and a rotary motor located within the base at each of the plurality of mixing locations and each magnetically coupled to the at least two arms so as to cause the elongate stirring member to rotate with the rotary motor.

According to a further embodiment of the present invention there is disclosed a method for mixing a liquid comprising providing a base having an associated head located thereover, locating an elongate stirring member within a container holding a liquid to be mixed, the stirring member extending between top and bottom ends along an axis, wherein the top end is magnetically coupleable with the head so as to suspend the elongate stirring member therefrom and wherein the bottom end includes at least two arms radially extending therefrom; placing the container on the base at a mixing location so as to magnetically couple the stirring member with the head; and turning a rotary motor located within the base magnetically coupled to the at least two arms so as to cause the elongate stirring member to rotate with the rotary motor.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for mixing a liquid according to a first embodiment of the present invention.

FIG. 2 is a cross sectional view of the apparatus of FIG. 1 through the plane 2-2 with a container containing a liquid to be mixed thereinto.

FIG. 3 is a cross sectional view of the apparatus of FIG. 1 through the plane 2-2 with the container located therein at an operating or mixing configuration.

FIG. 4 is a perspective view of an apparatus for mixing liquids in a plurality of containers according to a further embodiment of the present invention.

### DETAILED DESCRIPTION

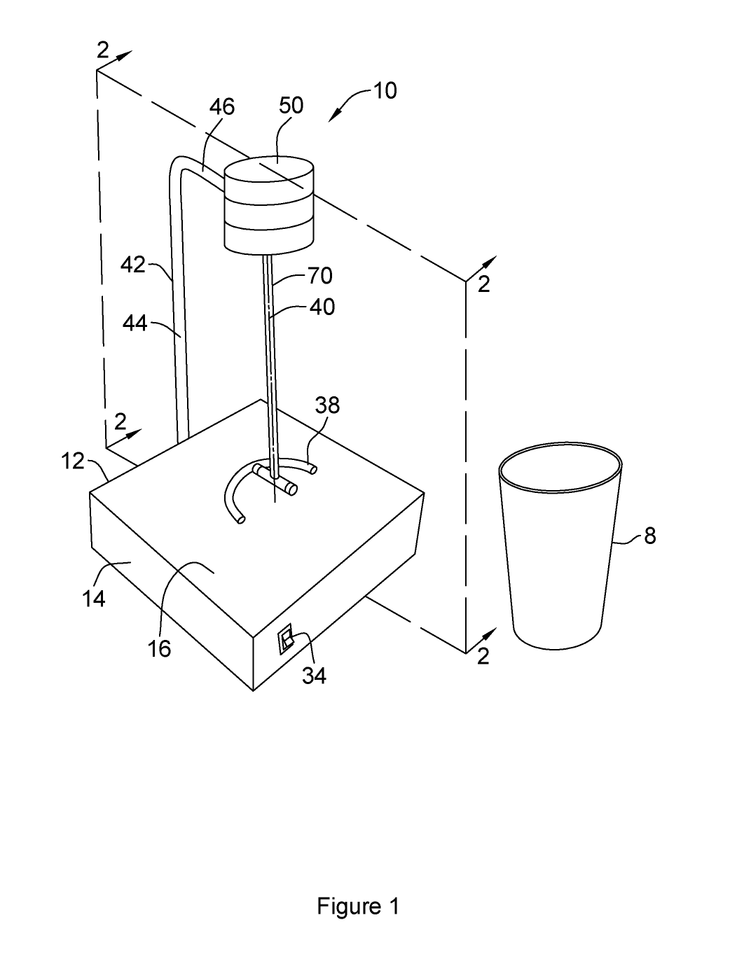

Referring to FIG. 1, an apparatus for mixing liquids within a container 8 according to a first embodiment of the invention is shown generally at 10. The apparatus 10 comprises a base 12 having an associated head 50 located thereover. The apparatus further includes an elongate stirring member 70 having a bottom mixing end adapted to be suspended from the head 50 into a container 8 so as to be rotatable therein, as will be further set out below, thereby mixing the contents of the container 8.

The base 12 includes a casing 14, having a top surface 16, formed with a non-ferrous material. An arcuate rear guide bar 38 is secured to the top surface 16, such that the open centre thereof is aligned below the centre of the head 50 above along a vertical stirring axis 40, and is adapted to receive the base of the container 8 therein.

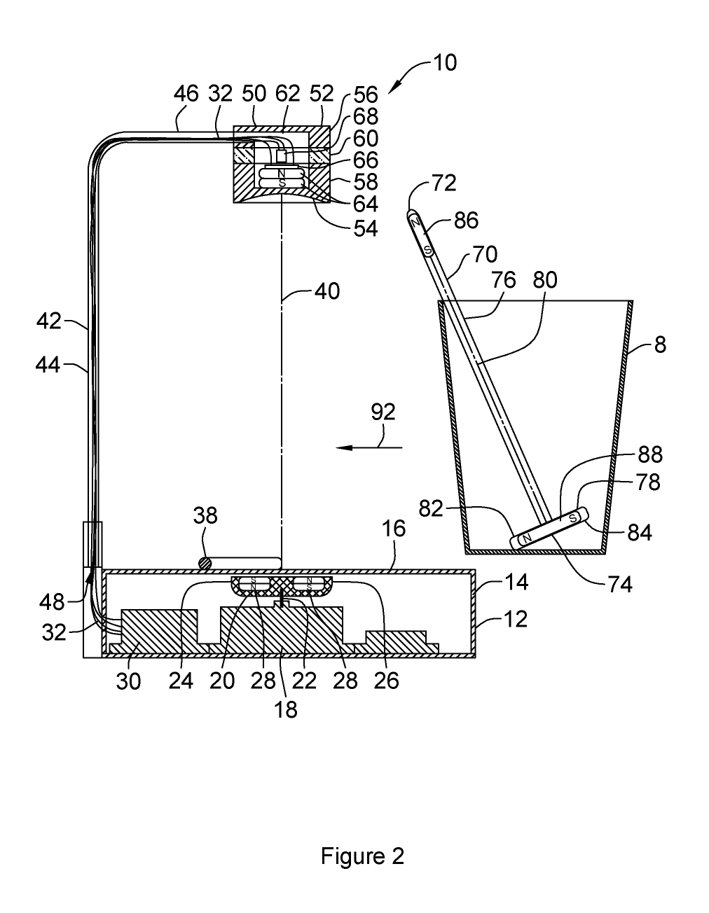

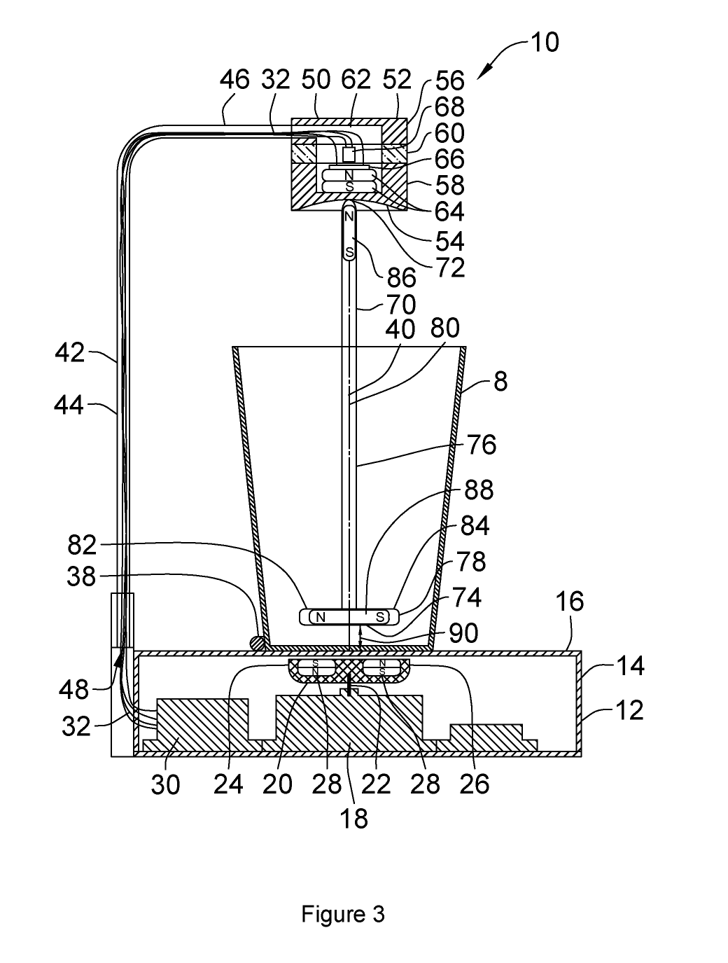

Turning now to FIGS. 2 and 3, the casing 14 includes a motor 18 therein, positioned such that the rotor 20, connected to the motor 18 with a shaft 22 therebetween, is centered on the vertical stirring axis 40. The rotor 20 extends between first and second ends, 24 and 26, respectively, and includes a plurality of drive magnets 28 therein, at each of the first and second ends 24 and 26. The drive magnets 28 positioned proximate to the first end 24 are installed such that the polarity is opposite to the drive magnets 28 positioned proximate to the second end 26, such as, by way of non-limiting example, the drive magnets 28 proximate to the first end 24 may be installed with the south end of the drive magnets 28 facing up towards the top surface 16, while the drive magnets 28 positioned proximate to the second end 26 may be installed with the north end of the drive magnets 28 facing up towards the top surface 16. Optionally, the drive magnet may be formed with a single magnet with the north and south ends at each end of the rotor 20. The drive magnets 28 may be rare earth magnets, such as neodymium and samarium-cobalt magnets, by way of non-limiting example as are commonly known, although other types of magnets such as ferromagnetic permanent magnets may be useful, as well.

A control system 30 is located within the casing 14, and is connected to the motor 18, as is commonly known. A plurality of wires 32 connect to the control system 30 and extend from the base 12 to the head 50, the purpose of which will be described in more detail below. The control system 30 may also optionally include an activation switch 34 (shown on FIG. 1) to power the motor 18 on or off, and may also control the motor speed and timing, as well as other functions, as desired.

An elongate, tubular positioning arm 42 extends between the base 12 and the head 50. The positioning arm 42 includes a vertical portion 44 extending from the base 12, parallel to and spaced apart from the vertical stirring axis 40, and a horizontal portion 46 extending to the head 50, parallel to and spaced from the top surface 16. The vertical portion 44 is sized to allow a container 8 to be received between the head 50 and the base 12, while the horizontal portion 46 is sized to position the centre of the head 50 along the stirring axis 40. The positioning arm 42 includes a passage 48 therethrough, through which the plurality of wires 32 pass and connect from the control system 30 in the base 12 to the head 50, as will be set out further below.

The cylindrical head 50 extends between top and bottom surfaces, 52 and 54, respectively, with the cylinder centered on the stirring axis 40. The head 50 comprises top and bottom portions, 56 and 58, respectively, with a transparent indicator portion 60 therebetween. The top and bottom portions, 56 and 58, may be formed of any suitable non-ferrous material, such as, by way of non-limiting example, stainless steel. The indicator portion 60 may be formed of any suitable clear material, such as, by way of non-limiting example, acrylic. The bottom surface 54 is concave, as shown in FIGS. 2 and 3.

The head 50 includes a cavity 62 therein sized to receive a plurality of suspension magnets 64 therein, as well as a coil inductor 66 adapted to sense the proximity of a suspended magnet 86 within the elongate stirring member 70 and an LED light 68. The horizontal portion 46 of the positioning arm 42 is attached to the head 50 such that the cavity 62 connects to the passage 48, through which the wires 32 pass.

The suspension magnets 64 are centered over the stirring axis 40 proximate to the bottom surface 54 within the cavity 62. The plurality of suspension magnets 64 are installed with the south end of each suspension magnet 64 facing down towards the bottom surface 54. The size and number of suspension magnets 64 is selected such that the magnetic force overcomes the force of the plurality of drive magnets 28 in the base 12, as will be described further below. The suspension magnets 64 may be rare earth magnets, such as neodymium and samarium-cobalt magnets, by way of non-limiting example as are commonly known, although other types of magnets such as ferromagnetic permanent magnets and electromagnets may be useful, as well. A coil inductor 66 is positioned within the cavity and engages upon the top suspension magnet 64. The coil inductor 66 is connected to the control system 30 by the wires 32. An LED light 68 is positioned in the cavity 62 within the indicator portion 60 of the head 50, and is also connected to the control system 30 by the wires 32. As illustrated, two suspension magnets 64 are utilized, however it will be appreciated that more or less may also be utilized to provide the desired degree of suspension force to the elongate stirring member 70. As illustrated in FIG. 1, a sensor 96 of any known type may be included onto the elongate stirring member. The sensor 96 may wireless or wired to transmit any desired data, such as by way of non-limiting example, pH, temperature or chemical composition to a display 98 or other source.

The elongate stirring member 70 extends between top and bottom ends, 72 and 74, respectively, and comprises an elongate rod portion 76, extending between the top and bottom ends, 72 and 74, along a rod axis 80, and a stirring end portion 78 at the bottom end 74 thereof. The elongate stirring member 70 is sized such that when it is in the operating position, as illustrated in FIG. 3, a gap 90 is formed between the bottom end 74 and the top surface 16 of the base 12. The gap 90 may be in the range of such as, by way of non-limiting example, ½″ to ¾″ (13 mm to 19 mm), although other gap distances may be useful, as well. The stirring end portion 78 comprises first and second arms, 82 and 84, extending radially from the distal end of the elongate rod portion 76. Although the current embodiment of the invention is illustrated with two arms, 82 and 84, it will be appreciated that other quantities of arms may be useful, as well.

A suspended magnet 86 is contained within the elongate rod portion 76 proximate to the top end 72. The suspended magnet 86 is positioned with the north end facing the top end 72 of the elongate stirring member 70 such that the suspended magnet 86 is magnetically attracted to the suspension magnets 64 in the head 50, when positioned in proximity to each other. A driven magnet 88 extends between the first and second arms 82 and 84 such that each arm has an opposite polarity. As illustrated, the first arm 82 contains the north end of the driven magnet 88, while the second arm 84 contains the south end of the driven magnet 88. The length of the first and second arms 82 and 84 and the driven magnet 88 therein are adapted to be attracted to the drive magnets 28 in the rotor 20. As illustrated, the first arm 82 is magnetically attracted to the first end 24 of the rotor 20, and the second arm 84 is magnetically attracted to the second end 26 of the rotor 20. The suspended magnet 86 and driven magnet 88 may be rare earth magnets, such as neodymium and samarium-cobalt magnets, by way of non-limiting example as are commonly known, although other types of magnets such as ferromagnetic permanent magnets may be useful, as well.

To operate the apparatus 10, the elongate stirring member 70 is located within the container 8, as illustrated in FIG. 2. The container 8 is placed on the base 12 and moved in a direction indicated at 92 until the container 8 engages upon the rear guide bar 38, as illustrated in FIG. 3. The suspended magnet 86 is attracted to the suspension magnets 64 within the head 50, and as the suspension magnets 64 are selected to have a greater magnetic force than the drive magnets 28, the elongate stirring member 70 is suspended from the head 50. The concave bottom surface 54 of the head 50 provides a minimal distance between the suspension magnets 64 and the bottom surface 54 at the centre of the head 50, such that the elongate stirring member 70 is magnetically attracted to the centre of the head 50 where it intersects with the stirring axis 40. The driven magnet 88 is magnetically attracted to the drive magnets 28 within the rotor 20, such that the elongate stirring member 70 is positioned with the rod axis 80 aligned to the stirring axis 40, as illustrated in FIG. 3.

When the elongate stirring member 70 is engaged upon the head 50, the coil inductor 66 detects the change in the magnetic field, thereby sending a signal to the control system 30. The control system 30 activates the motor 18, ramping up the speed from 0 to 1000 RPM, by non-limiting example, and activates the LED light 68 to glow red, indicating that the apparatus 10 is operating. The control system 30 allows the apparatus 10 to operate for a set period of time, then shuts the motor 18 off and changes the LED light 68 to glow green, indicating that operation has ceased, and stirring is complete.

Although the current embodiment of the invention includes an automatic control system 30 initiated with the coil inductor 66, it will be appreciated that the motor 18 could be operated by the user with an activation switch 34, set to engage the motor for a predetermined period of time. Additionally, the LED light 68 to indicate operation status may be optional.

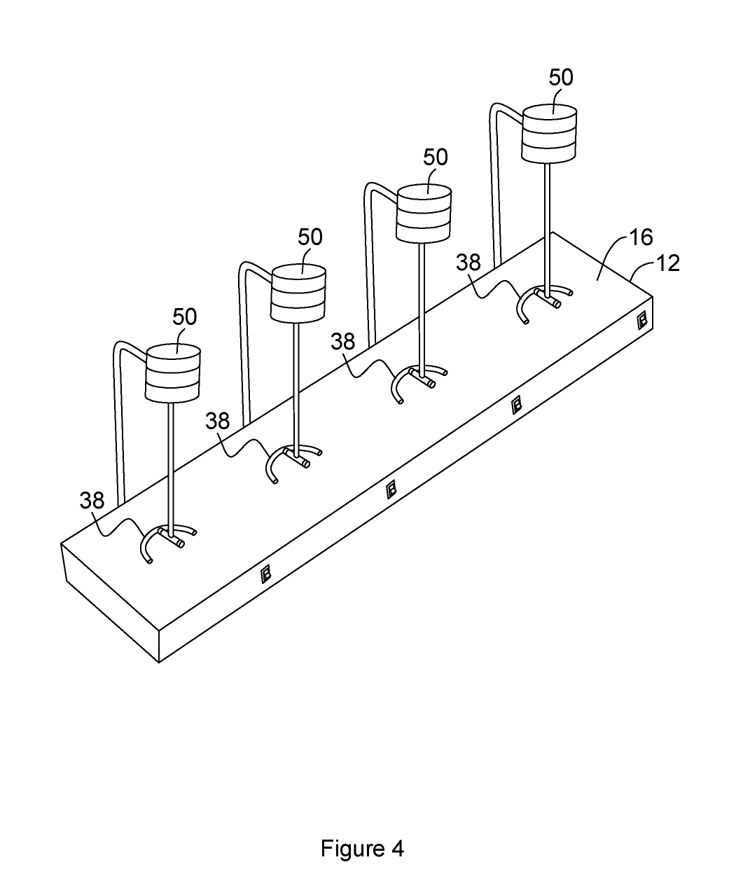

A further embodiment of the invention is illustrated in FIG. 4. In this embodiment, the base 12 is extended in size to allow for a plurality of mixing locations, as illustrated with a plurality of guide bars 38 distributed on the top surface 16 with associated heads 50 thereover. Within the base 12 are a plurality of motors 18 with rotors 20 aligned below the guide bars 38, as set out above. In this configuration, multiple containers may be independently mixed simultaneously, saving the user time.

While specific embodiments of the invention have been described and illustrated, such embodiments should be considered illustrative of the invention only and not as limiting the invention as construed in accordance with the accompanying claims.

What is claimed is:

1. An apparatus for mixing a liquid comprising:
a base having an associated head located thereover;
an elongate stirring member extending between top and bottom ends along an axis, wherein said top end is magnetically coupled with said head so as to suspend said elongate stirring member therefrom and wherein said bottom end includes at least two arms radially extending therefrom; and
a rotary motor located within said base magnetically coupled to said at least two arms so as to cause said elongate stirring member to rotate with said rotary motor.

2. The apparatus of claim 1 wherein each of said at least two arms includes a driven magnet in a distal end thereof from said axis.

3. The apparatus of claim 2 wherein said driven magnets have opposite polarity from each other.

4. The apparatus of claim 2 wherein said at least two arms comprises two arms extending in opposite directions from each other from said axis.

5. The apparatus of claim 1 wherein said stirring member is formed of a ferromagnetic material.

6. The apparatus of claim 1 wherein said stirring member includes a suspended magnet at said top end thereof.

7. The apparatus of claim 1 wherein said head is positioned above said base by a positioning arm.

8. The apparatus of claim 1 wherein said head includes a suspension magnet therein for suspending said stirring member.

9. The apparatus of claim 8 wherein said suspension magnet is oriented to attract said stirring member.

10. The apparatus of claim 1 wherein said suspension magnet is encased within a non-magnetic material.

11. The apparatus of claim 1 wherein said head includes an induction switch adapted to sense the presence of said stirring member and to selectively activate said motor in response thereto.

12. The apparatus of claim 1 wherein said base includes a platform for supporting a container containing a liquid to be mixed therein.

13. The apparatus of claim 12 wherein said motor is located below said platform.

14. The apparatus of claim 12 wherein said platform includes a positioning member to position said container at the desired location for mixing.

15. The apparatus of claim 12 wherein said motor includes a rotary member magnetically coupleable to said arms of said stirring member.

16. The apparatus of claim 15 wherein said rotary member includes a pair of drive magnets disposed thereon coupleable to said arms of said stirring member.

17. The apparatus of claim 16 wherein said drive magnets have opposite polarity from each other.

18. The apparatus of claim 11 wherein said head includes a light adapted to be illuminated when said motor is activated.

19. A kit for stirring liquids comprising
a base having a plurality of mixing locations each having an associated head located thereover;
a plurality of elongate stirring members extending between top and bottom ends along an axis, wherein said top end is magnetically coupled with said head so as to suspend said elongate stirring member therefrom and wherein said bottom end includes at least two arms radially extending therefrom; and
a rotary motor located within said base at each of said plurality of mixing locations and each magnetically coupled to said at least two arms so as to cause said elongate stirring member to rotate with said rotary motor.

20. A method for mixing a liquid comprising:
providing a base having an associated head located thereover;
locating an elongate stirring member within a container holding a liquid to be mixed, said stirring member extending between top and bottom ends along an axis, wherein said top end is magnetically coupleable with said head so as to suspend said elongate stirring member therefrom and wherein said bottom end includes at least two arms radially extending therefrom;
placing said container on said base at a mixing location so as to magnetically couple said stirring member with said head; and
turning a rotary motor located within said base magnetically coupled to said at least two arms so as to cause said elongate stirring member to rotate with said rotary motor.
